(19) United States
(12) Patent Application Publication
(10) Pub. No.: US 2019/0176523 A1
(43) Pub. Date: Jun. 13, 2019

(54) PNEUMATIC TIRE

(71) Applicant: TOYO TIRE & RUBBER CO., LTD., Itami-shi (JP)

(72) Inventor: Masashi Nakamura, Itami-shi (JP)

(73) Assignee: TOYO TIRE & RUBBER CO., LTD., Itami-shi (JP)

(21) Appl. No.: 16/197,612

(22) Filed: Nov. 21, 2018

(30) Foreign Application Priority Data
Dec. 7, 2017 (JP) 2017-235008

(51) Int. Cl. B60C 11/01

(52) U.S. Cl. CPC B60C 11/01; B60C 2011/0341; B60C 2011/013

(57) ABSTRACT

Provided are a tread portion which includes a plurality of main grooves extending in a tire circumferential direction, and a buttress portion provided outside the tread portion in a tire width direction. The buttress portion includes at least a first side groove formed on an outer side in a tire radial direction, and a second side groove formed on an inner side in the tire radial direction with a groove bottom line interposed between the first side groove and the second side groove. The groove bottom line connects groove bottoms of the main grooves.

### CROSS-REFERENCE TO RELATED APPLICATIONS

This application claims priority based on Japanese Patent Application No. 2017-235008 filed Dec. 7, 2017, the contents of which are incorporated herein by this reference.

### BACKGROUND OF THE INVENTION

### Field of the Invention

The present invention relates to a pneumatic tire.

### Description of Related Art

A pneumatic tire conventionally known includes a buttress portion which has narrow grooves extending in a tire circumferential direction, and a plurality of sipes extending in a tire radial direction and opened to the narrow grooves (e.g., see Japanese Patent Publication No. 4230574).

However, the narrow grooves of the conventional pneumatic tire are formed apart from a ground contact surface. Therefore, an effect of reducing ground contact pressure at a shoulder portion provided on an outer part of the ground contact surface in the tire radial direction becomes insufficient in an initial wear stage of the ground contact surface. In this case, uneven wear may occur.

### SUMMARY

An object of the present invention is to provide a pneumatic tire capable of appropriately preventing uneven wear from a wear initial stage of a ground contact surface.

For achieving the aforementioned object, a pneumatic tire according to the present invention comprises: a tread portion that includes a plurality of main grooves extending in a tire circumferential direction; and a buttress portion provided on an outside of the tread portion in a tire width direction, wherein the buttress portion includes at least a first side groove formed on an outer side in a tire radial direction, and a second side groove formed on an inner side in the tire radial direction with a groove bottom line interposed between the first side groove and the second side groove, the groove bottom line connecting groove bottoms of the main grooves.

According to this configuration, the first side groove formed on the outer side in the tire radial direction with respect to the groove bottom line reduces ground contact pressure to prevent uneven wear in an initial wear stage of the tire. In a complete wear state where the main grooves disappear, the second side groove formed on the inner side in the tire radial direction with respect to the groove bottom line reduces ground contact pressure to prevent uneven wear.

It is preferable that the first side groove has a larger groove depth than a groove depth of the second side groove.

According to this configuration, rigidity of a portion close to the ground contact surface sufficiently decreases, wherefore appropriate ground contact pressure is allowed to be produced from the wear initial stage.

It is preferable that the second side groove has a smaller groove width than a groove width of the first side groove.

According to this configuration, rigidity of a portion apart from the ground contact surface does not decrease, wherefore desired steering stability performance is produced.

It is preferable that the first side groove and the second side groove are disposed along the groove bottom line.

According to this configuration, rigidity throughout the circumference in the tire circumferential direction can be constant with positions of the side grooves fixed in the tire radial direction.

It is preferable that a groove bottom of each of the first side groove and the second side groove has a curved surface having an arcuate cross section.

According to this configuration, cracks are not easily produced in the groove bottoms of the side grooves.

It is preferable that each of the first side groove and the second side groove has a groove depth in a range from 5 mm inclusive to 10 mm inclusive.

According to this configuration, an effect of reducing rigidity and decreasing ground contact pressure is sufficiently achievable, and deterioration of desired steering stability performance caused by excessive decrease in rigidity is avoidable.

According to the present invention, the first side groove and the second side groove are respectively formed on both sides of the buttress portion with the groove bottom line interposed between the respective sides. In this case, ground contact pressure can be kept in an appropriate state from the initial wear stage to the complete wear stage where the main grooves disappear. Accordingly, prevention of uneven wear is achievable.

### BRIEF DESCRIPTION OF THE DRAWINGS

The foregoing and the other feature of the present invention will become apparent from the following description and drawings of an illustrative embodiment of the invention in which:

FIG. 1 is a meridian cross-sectional view showing a part of a pneumatic tire according to the present embodiment;

FIG. 2 is a meridian cross-sectional view showing a part of a pneumatic tire according to another embodiment;

FIG. 3 is a meridian cross-sectional view showing a part of a pneumatic tire according to another embodiment;

FIG. 4 is a meridian cross-sectional view showing a part of a pneumatic tire according to another embodiment; and

FIG. 5 is a meridian cross-sectional view showing a part of a pneumatic tire according to another embodiment.

### DETAILED DESCRIPTION OF EMBODIMENTS

An embodiment according to the present invention is hereinafter described with reference to the accompanying drawings. It should be noted that the following description is essentially presented by way of example, and not intended to limit the present invention, applicable ranges of the present invention, or purposes of use of the present invention. In addition, the accompanying drawings are only schematic figures, and do not show actual ratios or the like of respective dimensions.

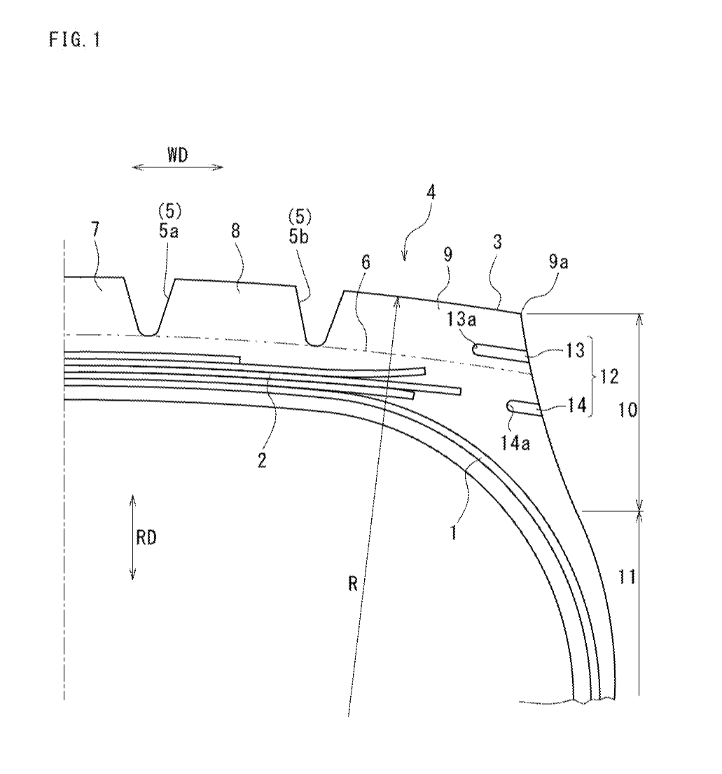

FIG. 1 is a meridian half cross-sectional view showing a part of a pneumatic tire according to the present embodiment, particularly a heavy-load tire for a large-sized vehicle such as a truck or a bus herein.

The pneumatic tire shown in FIG. 1 includes bead cores (not shown) annularly connected at both sides in a tire width direction WD. A carcass ply 1 extends between the bead cores. A plurality of belts 2 are wound around a center portion of the carcass ply 1 in the tire width direction WD on the outer side in a tire radial direction RD. The outside of the belt 2 in the tire radial direction RD constitutes a tread portion 4 which includes a ground contact surface 3 in contact with a road surface during traveling.

The tread portion 4 includes a plurality of main grooves 5 connected in a tire circumferential direction. Groove depths of the respective main grooves 5 from the ground contact surface 3 are equalized with each other. A line connecting groove bottoms of the main grooves 5 is herein defined as a groove bottom line 6 (indicated by a curved line in the meridian cross section of FIG. 1, but in practice constituting a cylindrical surface whose outside diameter gradually changes in an axial direction). The groove bottom line 6 is formed inside in the tire radial direction RD at regular intervals with respect to the ground contact surface 3.

The main grooves 5 are constituted by four grooves, i.e., two first main grooves 5a in a center part in the tire width direction, and two second main grooves 5b in an outer part. A center rib 7 is formed between the first main grooves 5a and connected in the tire circumferential direction. A mediate rib 8 is formed between the first main groove 5a and the second main groove 5b. A shoulder rib 9 is formed on the outside of the second main groove 5b in the tire width direction.

A tip of the shoulder rib 9 on the outside of a rib end 9a in the tire width direction constitutes a buttress portion 10 and a side wall portion 11 both extending inward in the tire radial direction.

The buttress portion 10 includes a plurality of side grooves 12 connected in a tire circumferential direction along the groove bottom line 6 when viewed in the meridian cross section. Each groove width of the side grooves 12 has a sufficiently small length of 1 mm or smaller. In addition, each of the side grooves 12 has such a shape that a center line of the side groove 12 is inclined in a range of ±25° with respect to a tangent line passing through the rib end 9a of the ground contact surface (radius of curvature R) of the shoulder rib 9.

The side grooves 12 include a first side groove 13 formed on the outer side in the tire radial direction, and a second side groove 14 formed on the inner side, with the groove bottom line 6 interposed between the first and second side grooves 13 and 14.

The first side groove 13 extends from a surface of the buttress portion 10 to the inside in the tire width direction along the groove bottom line 6. A groove bottom of the first side groove 13 is constituted by a groove bottom 13a having an arcuate cross section, and has no corner portion. Accordingly, even when the shoulder rib 9 deformed by ground contact pressure during traveling compresses the buttress portion 10, cracks are not easily produced in the groove bottom 13a. A groove depth of the first side groove 13 (distance from surface of buttress portion 10 to groove bottom 13a) is set within a range from 5 mm inclusive to 10 mm inclusive. By setting the groove depth of the first side groove 13 within this range, rigidity of the shoulder rib 9 can be sufficiently reduced to adjust the ground contact pressure to an appropriate value. In other words, the ground contact pressure at the shoulder rib 9 can be constant throughout the shoulder rib 9. Accordingly, reduction of uneven wear at the shoulder rib 9 is achievable.

Similarly to the first side groove 13, the second side groove 14 extends from the surface of the buttress portion 10 toward the inside in the tire width direction along the groove bottom line 6. A groove depth of the second side groove 14 is set in a range from 5 mm inclusive to 10 mm inclusive. A groove bottom 14a of the second side groove 14 is constituted by a curved surface having an arcuate cross section, and has no corner portion similarly to the configuration of the first side groove 13. However, the second side groove 14 has a smaller groove depth and a smaller groove width than those of the first side groove 13. When the second side groove 14 formed on the inner side in the tire radial direction has a large groove depth and a large groove width, the buttress portion 10 is deformable too easily. Accordingly, in comparison with the first side groove 13, a deformation amount of the buttress portion 10 needs to be reduced. This configuration therefore secures steering stability performance required for cornering or other occasions.

According to the pneumatic tire having the above configuration, the buttress portion 10 includes the first side groove 13 formed on the outer side in the tire radial direction, and the second side groove 14 formed on the inner side in the tire radial direction. This configuration improves a rigidity balance at the shoulder ribs 9, thereby reducing variations in the ground contact pressure. Accordingly, reduction of uneven wear at the shoulder rib 9 is achievable. Moreover, even when wear of the ground contact surface 3 of the tire develops and comes into a complete wear stage where the main grooves 5 disappear, an appropriate rigidity balance can be secured by the presence of the second side groove 14. The second side groove 14 has a groove depth smaller than that of the first side groove 13. In this case, rigidity of the buttress portion 10 does not excessively decrease until the complete wear stage, wherefore desirable steering stability performance can be produced. In this manner, uneven wear at the shoulder rib 9 can be appropriately prevented even in the period from the initial wear stage to the complete wear stage. In addition, steering stability performance can be secured.

The present invention is not limited to the configuration described in the embodiment herein, but includes various other modifications.

In the above embodiment, the two side grooves 12 are provided. However, the number of the side grooves 12 may be three or more. When three or more grooves are provided, the side grooves 12 are preferably disposed at regular intervals for constant rigidity in the tire radial direction. However, the side grooves 12 are required to be formed at least one for each of the outer side and the inner side in the tire radial direction with the groove bottom lines 6 interposed between the respective sides.

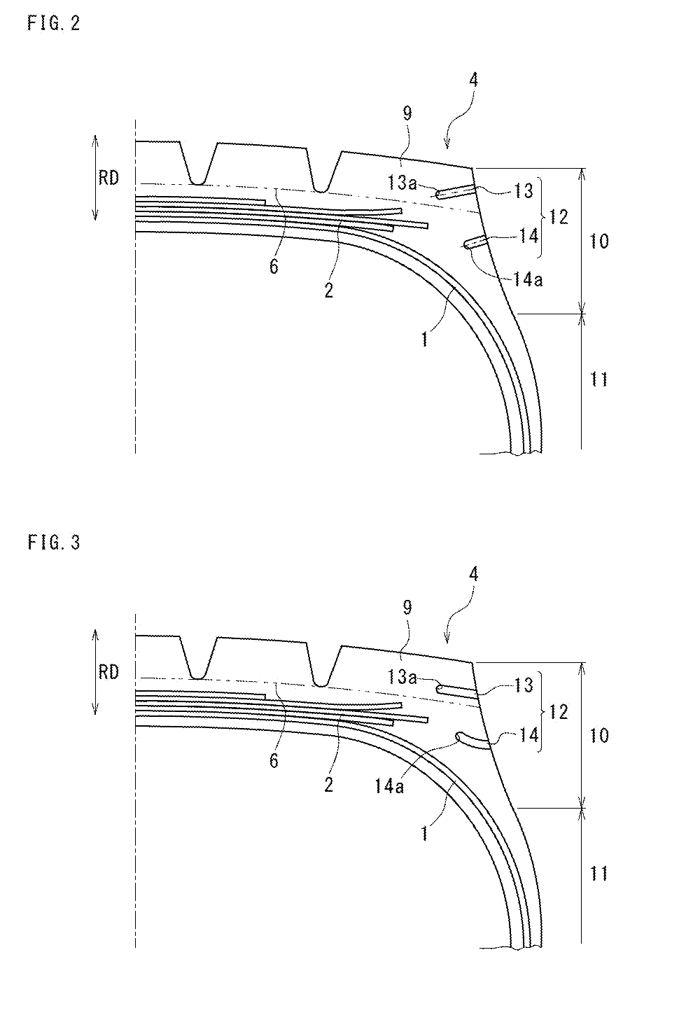

In the above embodiment, the side grooves 12 are configured to extend along the groove bottom line 6 also in the depth direction. However, other configurations shown in FIGS. 2 to 5 may be adopted.

In FIG. 2, the first side groove 13 and the second side groove 14 are both inclined toward the inside in the tire radial direction RD with respect to the groove bottom line 6 as the first side groove 13 and the second side groove 14 extend from the surface of the buttress portion 10 toward the groove bottoms 13a and 14a. In other words, both the first side groove 13 and the second side groove 14 are so formed as to cross the surface of the buttress portion 10 substantially at right angles. According to this configuration, a defective flow of rubber at the time of vulcanization molding is avoidable, and a bare (phenomenon which prevents vulcanization molding of rubber defective flow portion in accordance with mold) are not easily caused in comparison with the configuration described in the above embodiment.

In FIG. 3, the first side groove 13 is so formed as to extend from the surface of the buttress portion 10 toward the groove bottom 13a along the groove bottom line 6 similarly to the embodiment described above. However, the second side groove 14 is curved from the surface of the buttress portion 10 toward the groove bottom 14a to approach the groove bottom line 6.

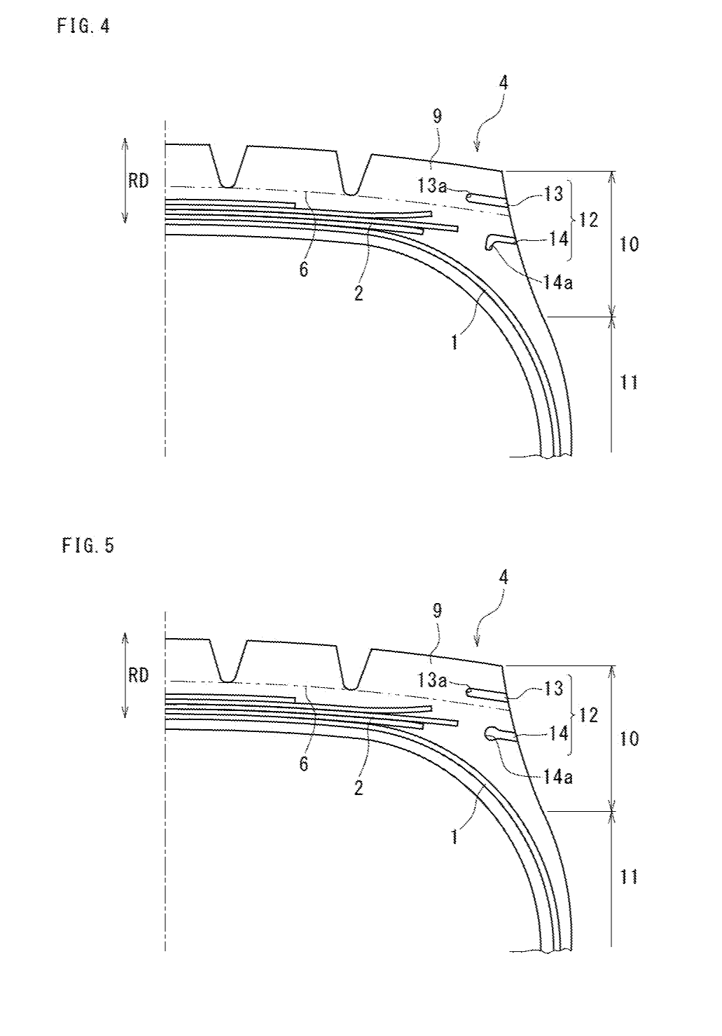

In FIG. 4, the first side groove 13 is so formed as to extend from the surface of the buttress portion 10 toward the groove bottom 13a along the groove bottom line 6 similarly to the embodiment described above. However, the second side groove 14 on the groove bottom 14a side is bent toward the inside in the tire radial direction.

In FIG. 5, the first side groove 13 is so formed as to extend from the surface of the buttress portion 10 toward the groove bottom 13a along the groove bottom line 6 similarly to the embodiment described above. However, the groove bottom 14a of the second side groove 14 has an expanded circular cross section. Cracks are generally produced in the groove bottom 14a. Accordingly, by increasing the radius of curvature of the groove bottom 14a, reduction of stress concentration on the groove bottom 14a, and therefore reduction of cracks from the groove bottom 14a are achievable.

What is claimed is:

1. A pneumatic tire comprising:
a tread portion that includes a plurality of main grooves extending in a tire circumferential direction; and
a buttress portion provided on an outside of the tread portion in a tire width direction,
wherein the buttress portion includes at least a first side groove formed on an outer side in a tire radial direction, and a second side groove formed on an inner side in the tire radial direction with a groove bottom line interposed between the first side groove and the second side groove, the groove bottom line connecting groove bottoms of the main grooves.

2. The pneumatic tire according to claim 1, wherein the first side groove has a larger groove depth than a groove depth of the second side groove.

3. The pneumatic tire according to claim 1, wherein the second side groove has a smaller groove width than a groove width of the first side groove.

4. The pneumatic tire according to claim 2, wherein the second side groove has a smaller groove width than a groove width of the first side groove.

5. The pneumatic tire according to claim 1, wherein the first side groove and the second side groove are disposed along the groove bottom line.

6. The pneumatic tire according to claim 2, wherein the first side groove and the second side groove are disposed along the groove bottom line.

7. The pneumatic tire according to claim 3, wherein the first side groove and the second side groove are disposed along the groove bottom line.

8. The pneumatic tire according to claim 4, wherein the first side groove and the second side groove are disposed along the groove bottom line.

9. The pneumatic tire according to claim 1, wherein a groove bottom of each of the first side groove and the second side groove has a curved surface having an arcuate cross section.

10. The pneumatic tire according to claim 2, wherein a groove bottom of each of the first side groove and the second side groove has a curved surface having an arcuate cross section.

11. The pneumatic tire according to claim 3, wherein a groove bottom of each of the first side groove and the second side groove has a curved surface having an arcuate cross section.

12. The pneumatic tire according to claim 4, wherein a groove bottom of each of the first side groove and the second side groove has a curved surface having an arcuate cross section.

13. The pneumatic tire according to claim 5, wherein a groove bottom of each of the first side groove and the second side groove has a curved surface having an arcuate cross section.

14. The pneumatic tire according to claim 6, wherein a groove bottom of each of the first side groove and the second side groove has a curved surface having an arcuate cross section.

15. The pneumatic tire according to claim 7, wherein a groove bottom of each of the first side groove and the second side groove has a curved surface having an arcuate cross section.

16. The pneumatic tire according to claim 8, wherein a groove bottom of each of the first side groove and the second side groove has a curved surface having an arcuate cross section.

17. The pneumatic tire according to claim 1, wherein each of the first side groove and the second side groove has a groove depth in a range from 5 mm inclusive to 10 mm inclusive.

18. The pneumatic tire according to claim 2, wherein each of the first side groove and the second side groove has a groove depth in a range from 5 mm inclusive to 10 mm inclusive.

19. The pneumatic tire according to claim 3, wherein each of the first side groove and the second side groove has a groove depth in a range from 5 mm inclusive to 10 mm inclusive.

20. The pneumatic tire according to claim 4, wherein each of the first side groove and the second side groove has a groove depth in a range from 5 mm inclusive to 10 mm inclusive.
